(19) United States
(12) Patent Application Publication
(10) Pub. No.: US 2004/0123136 A1
(43) Pub. Date: Jun. 24, 2004

(54) Method for modifying executing file on real time and method for managing virus infected file using the same

(75) Inventor: Deok-Young Jung, Seoul (KR)

Correspondence Address: GREENBLUM & BERNSTEIN, P.L.C., 1950 ROLAND CLARKE PLACE, RESTON, VA, 20191, US

(73) Assignee: AHNLAB, INC., Seoul (KR)

(21) Appl. No.: 10/732,530

(22) Filed: Dec. 11, 2003

(30) Foreign Application Priority Data
Dec. 12, 2002 (KR) 2002-79231

(51) Int. Cl. G06F 12/14; G06F 12/00

(52) U.S. Cl. 713/200; 711/6

(57) ABSTRACT

A method for modifying an executing file on real time and a method for treating a virus using the same. The method for treating a virus in real-time includes the steps of: a) obtaining a file object of the executing file to be modified; b) modifying an original image stored on an address of a physical memory indicated by an image section of the executing file; c) modifying a data image stored on an address of a physical memory indicated by a data section of the executing file; d) obtaining a virtual memory address on which the executing file is loaded; and e) modifying a private image on the virtual memory address.

### FIELD OF THE INVENTION

The present invention relates to a method for modifying an executing file on real time and a method for managing a virus infected file using the same; and, more particularly, to a method for modifying original data of an executing file on real time and a method for treating or curing a virus infected file using the same, without terminating the executing file or a computer system.

### DESCRIPTION OF RELATED ART

In general, an operating system supporting a virtual memory such as Windows® loads a portion of data included in an executing file on the virtual memory and a physical memory in order to manage the virtual memory and the physical memory effectively. The other portion of the data is directly read from the executing file at every time that the data is necessary. For this reason, the operating system prevents the executing file from being modified, and therefore, a user cannot modify the executing file. Even though the executing file may be modified, since the executing file before being modified is loaded on the memory, the executing file not modified is executed. Accordingly, the execution result of the executing file is not changed.

This characteristic of the operating system is exploited for preventing malicious codes, e.g., virus or worm, from being treated or cured. In order to solve this problem, after terminating or suspending processes using a module having the malicious codes enforcedly, the malicious codes on the module are treated or cured. In another case that the module used for a Window subsystem cannot be unloaded enforcedly, the virus infected module has been treated or cured only after rebooting the computer system.

For treating the virus, the conventional anti-virus program uses a file input/output (I/O) method which is provided by Windows. In the file I/O based modification method, if a file system driver receives a file-write request to the executing file, the file system driver regards the file write request as an error and the file-write request can not be executed. As a result, the file I/O based modification method cannot modify the executing file.

Since most of the active malicious codes are residing in the executing file, in order to treat the executing file having the malicious codes, the executing file should be forcedly terminated.

Compulsory termination of the process due to the virus considerably degrades the stability of the computer system and increases unnecessary operations of the user, which makes a user inconvenient. Therefore, it is necessary to provide a method and system for modifying codes of the executing file on real time without compulsory termination of the executing file or reboot of the computer system.

### SUMMARY OF THE INVENTION

It is, therefore, an object of the present invention to provide a method for modifying an executing file on real time and a method for treating a virus using the same.

In accordance with one aspect of the present invention, there is provided a method for modifying data of an executing file in real time, including the steps of: a) obtaining a file object of the executing file to be modified; b) modifying an original image stored on an address of a physical memory indicated by an image section of the executing file; c) modifying a data image stored on an address of a physical memory indicated by a data section of the executing file; d) obtaining a virtual memory address on which the executing file is loaded; and e) modifying a private image on the virtual memory address.

In accordance with another aspect of the present invention, there is provided a method for treating a virus in real-time while executing a virus infected file, the method including the steps of: a) obtaining a file object of the executing file to be modified; b) modifying an original image stored on an address of a physical memory indicated by an image section of the executing file; c) modifying a data image stored on an address of a physical memory indicated by a data section of the executing file; d) obtaining a virtual memory address on which the executing file is loaded; and e) modifying a private image on the virtual memory address.

In accordance with further another aspect of the present invention, there is provided a computer readable medium storing instructions for executing a method for treating a virus on real time while executing a virus infected file, the method including the steps of; a) obtaining a file object of the executing file to be modified; b) modifying an original image stored on an address of a physical memory indicated by an image section of the executing file; c) modifying a data image stored on an address of a physical memory indicated by a data section of the executing file; d) obtaining a virtual memory address on which the executing file is loaded; and e) modifying a private image on the virtual memory address.

### BRIEF DESCRIPTION OF THE DRAWINGS

The above and other objects and features of the instant invention will become apparent from the following description of preferred embodiments taken in conjunction with the accompanying drawings, in which:

FIG. 1 is a diagram showing a procedure of reading/writing data under Windows environment;

FIG. 2 is a diagram illustrating an internal section in accordance with the present invention;

FIG. 3 is a diagram depicting structure of a virtual memory used for an executing file;

FIG. 4 is a diagram illustrating a procedure of changing a private image in accordance with the present invention; and

FIG. 5 is a flow chart illustrating a method of modifying an executing file on real time in accordance with the present invention.

### DETAILED DESCRIPTION OF THE INVENTION

Hereinafter, a method for modifying an executing file on real time and a method for managing a virus infected file using the same will be described under Microsoft Windows 2000 environment as an embodiment. Some terminologies used in this specification can be retrieved from “Inside Microsoft Windows 2000 Third Edition” and “http://microsoft.com”. Therefore, for easy description definition for the terminologies will be skipped. However, it is apparent and well known to ordinary one skilled in the art that the present invention is not limited to Microsoft Windows 2000 environment.

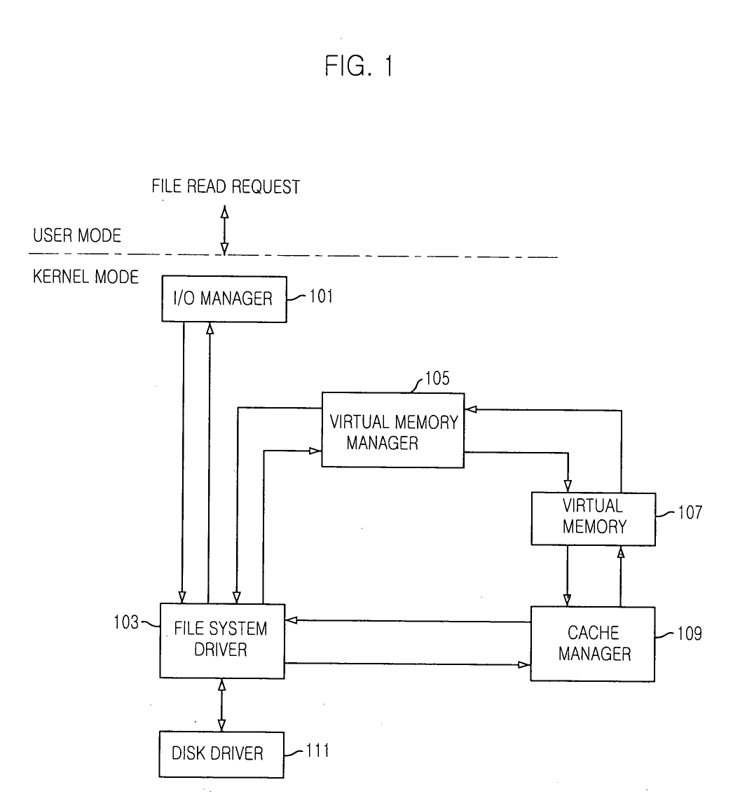

FIG. 1 is a diagram showing a procedure of reading data under Windows environment. As shown, the windows based system includes an input/output (I/O) manager 101, a file system driver 103, a virtual memory manager 105, a virtual memory 107, a cache manager 109 and a disk driver 111.

The I/O manager 101 receives a file read request signal, which is a signal requesting to read a file, from a user application through a read application programming interface (Read API) and finds a file system corresponding to the file based on the file read request signal. If the file read request signal is the first read request of the file, the file system driver 103 generates a section object for managing the cache. The section object is called as a file mapping object and represents a block of memory that two or more processes can share. If the file read request signal is not the first read request of the file or the section object is generated, the system driver 103 requests the cache manager 109 to read the file.

The cache manager 109 determines whether the file, which is requested to be read, has a view mapped to the virtual memory 107. If the file does not have any view mapped to the virtual memory 107, the cache manager 109 maps an address of a physical memory storing the file to the virtual memory 107. In the mapping process, a new section is generated to make a mapped view, and view mapping is performed in the new section. Then, the cache manager 109 requests to read data in a mapped area of the virtual memory.

The virtual memory 107 tries to read the data in the mapped area of the virtual memory based on the file reading request signal received from the cache manager 109. At this time, the virtual memory 107 does not have the data but has only the mapping information, accordingly, error occurs and a page fault signal is generated in the virtual memory 107. The page fault signal is transmitted to the virtual memory manager 105.

The virtual memory manager 105 receives the page fault signal and requests the file system driver 103 to send the data in response to the page fault signal based on file information mapped to the virtual memory 107. The data request signal generated by the virtual memory manager 105 is in the form of ‘NONCACHEED PAGING I/O FLAG’. The file system driver 103 receives READ IRP having a form of ‘NONCACHEED PAGING I/O FLAG’ and requests the disk driver 111 to send the data.

Then, the disk driver 111 reads the data from a disk. The data is provided to the virtual memory manager 105, and the data is stored in the virtual memory 107 where the page fault signal is generated.

The cache manager 109 reads the data from the mapped virtual memory 107, and the data is provided to the user application through the file system driver 103. This way, the data read request is completed.

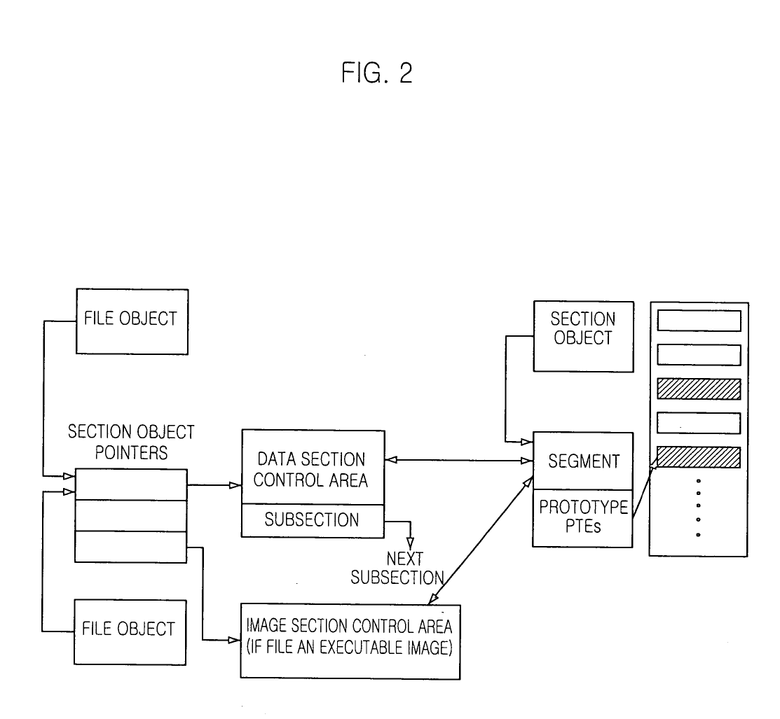

FIG. 2 is a diagram illustrating an internal section in accordance with the present invention.

Each open handle (read/write) to a file has a corresponding file object. For the file object, there is a single section object pointers structure. This structure is the key to maintaining data consistency for all types of file access as well as to providing caching for files. The section object pointers structure points to one or two control areas. One control area is used to map the file when it is accessed as a data file, and the other is used to map the file when it is run as an executable image.

A control area (a data section control area or an image section control area) in turn points to subsection structures that describe the mapping information for each section of the file. The control area also points to a segment structure allocated in paged pool, which in turn points to the prototype page table entries (PTEs) used to map to the actual pages mapped by the section object.

Meanwhile, when a file is executed initially, an original image section is generated by an image loader of the cache manager 109. When the file is requested to be read as data, a data section is generated. Also, when the image data is requested to be modified, the original image is duplicated to generate a private image page, in order to maintain the original page, which is referred as a Copy on Write function. In the present invention, an executing file can be modified by modifying all of the original image section, the data section and the private image page, to thereby detect and delete malicious codes or a virus.

Here, an image section is obtained by approaching to the section object by using a file object. The original image means data stored in the physical memory obtained from the image section. Also, the private image means data newly modified in a particular process by using a Copy on Write function of Windows®.

Meanwhile, when one file is used by a plurality of processes, the original image includes common codes, which are identical codes in the plurality of processes, while the private image includes only changed codes, which are codes different from each other process.

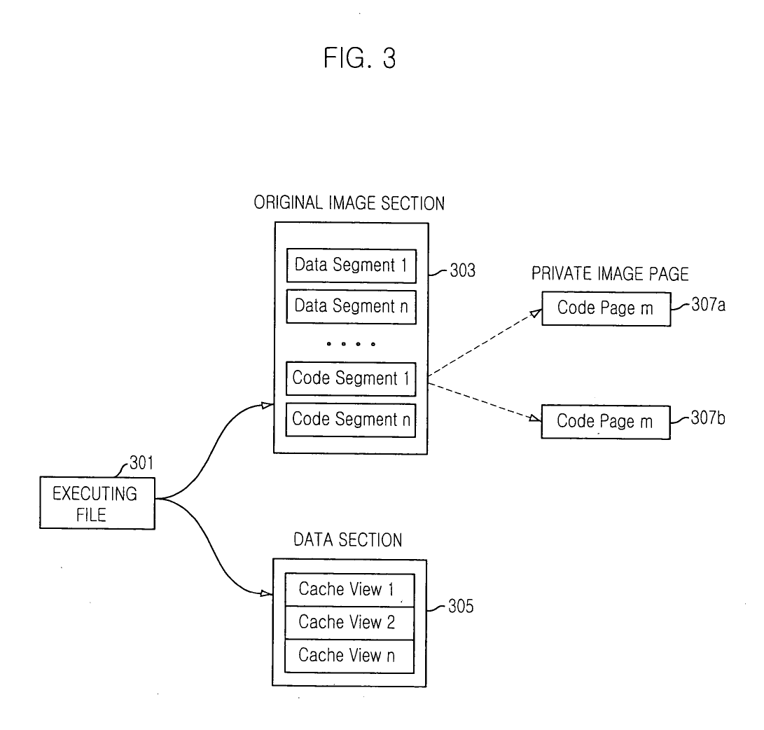

FIG. 3 is a diagram illustrating a structure of the virtual memory for an executing file. Executing file 301 indicates an original image section 303 and a data section 305 generated by the cache manager 109. When codes of the executing file need to be modified, the original image section 303 is duplicated by performing a new mapping, to thereby generate the private image page 307a or 307b.

The original image section 303 is generated by the section object, which is formed by the image loader, when a file is loaded. In the original image section, the physical memory storing the file is mapped to the virtual memory on a segment-by-segment basis. The original image data mapped to the original image section 303 is. read from the physical memory by the file system driver 103. The original image section 303 is divided into data segments for storing address information on which data of the file is stored and code segments for storing instructions of the file.

When two or more processes share a module and some codes of the module are modified by one process, the private image page 307a or 307b is duplicated so that the other processes are not affected by the code modification. The newly duplicated private image page is mapped to the corresponding process and, thus, the modified codes are applied to the mapped page.

The data section 305 is formed by the section object generated by the cache manager. The data section 305 is used to quickly respond to a data read request after the module is read. To respond quickly to the data read request, a cache view is mapped by the cache manager 109.

When particular codes are modified, a private image page is generated by the Copy on Write function. The private image page does not appear in the original image.

When a file is executed, a file object for the file is generated. The file object includes a section object pointer, and the section object pointer includes a data section object, a shared cache map and an image section object. Accordingly, the image section object can be obtained by the section object pointers, and the image section pointers are obtained by using the file object.

The image section pointers points structures of the original image section. A code segment of the file is extracted by using the image section pointers. A physical address of the original image data is found based on the code segment, and then, the original data stored on the physical address is modified.

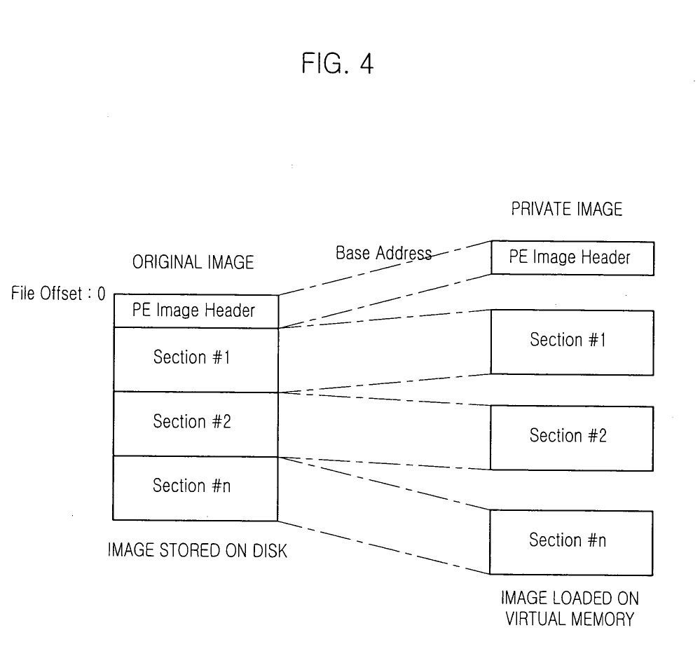

FIG. 4 is a diagram illustrating a structure of a portable executable (PE) file. This drawing shows file offset of the original image stored in the disk and an image loaded on the virtual memory. The original image having a portable executable (PE) structure is mapped to the virtual memory by the image loader.

To modify the private image, the data loaded on the virtual memory, which is pointed by the offset of the executing file, should be modified. Therefore, when the image of the file is loaded on the virtual memory, the address of the virtual memory is tracked by using a PE image header. The private image loaded on the virtual memory of which address is tracked, is modified.

The data section pointers point structures of the data section. A physical address of the data section is found based on the segment, and then, the data section stored on the physical address is modified. By modifying the data section on the physical address, a page writer used by the memory manager stores the data section of the physical memory in a disk and the modification of the executing file is completed.

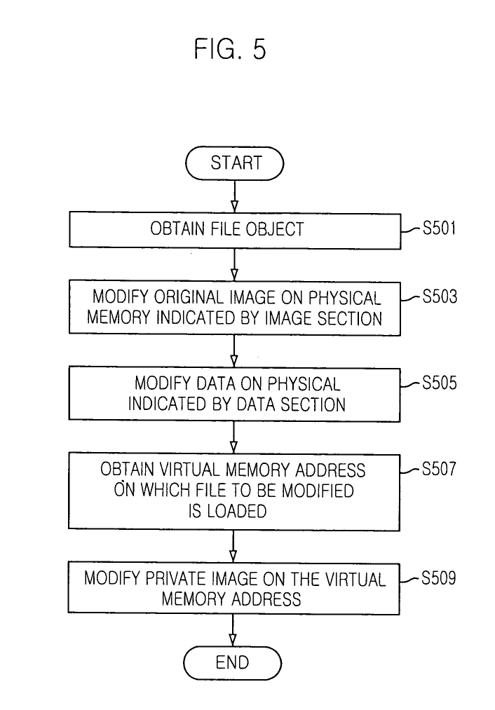

FIG. 5 is a flow chart illustrating a method of modifying an executing file on real time in accordance with the present invention.

First, a file object of an executing file, which is to be modified, is obtained at step S501. The original image stored on the address of the physical memory indicated by the image section of the executing file is modified at step S503. The data stored on the address of the physical memory indicated by the data section of the executing file is modified at step S505. A virtual memory address on which the executing file is loaded is obtained at step S507. The private image on the virtual memory address is modified at step S509.

Since the method of the present invention can modify the original image, the private image and the data section of the executing file, it is possible to modify the executing file and to treat or cure a file including malicious codes, i.e., a virus, without shutting down a process compulsorily.

In the present invention, since the executing file can be modified and a virus can be treated without terminating the virus infected process.

While the present invention has been described with respect to certain preferred embodiments, it will be apparent to those skilled in the art that various changes and modifications may be made without departing from the scope of the invention as defined in the following claims.

What is claimed is:

1. A method for modifying data of an executing file in real time, comprising the steps of:
a) obtaining a file object of the executing file to be modified;
b) modifying an original image stored on an address of a physical memory indicated by an image section of the executing file;
c) modifying a data image stored on an address of a physical memory indicated by a data section of the executing file;
d) obtaining a virtual memory address on which the executing file is loaded; and
e) modifying a private image on the virtual memory address.

2. The method as recited in claim 1, wherein the step b) includes the steps of:
b1) extracting an image section;
b2) extracting an address of a physical memory to which the image section is mapped; and
b3) modifying the original image mapped to the address of the physical memory.

3. The method as recited in claim 2, wherein the step b1) includes the steps of:
b1-1) detecting a section object pointers included in the file object;
b1-2) obtaining an image section pointers based on the section object pointers; and
b1-3) extracting the image section based on the image section pointers.

4. The method as recited in claim 1, wherein the step c) includes the steps of:
c1) extracting a data section of the executing file;
c2) extracting an address of a physical memory to which the data section is mapped; and
c3) modifying the data image loaded on the physical memory address; and
C4) at a page writer, writing the data image of the physical memory to a disk.

5. The method as recited in claim 4, wherein the step cl) includes the steps of:
c1-1) detecting a section object pointers included in the file object;
c1-2) obtaining a data section pointers based on the section object pointers; and
c1-3) extracting the data section based on the data section pointers.

6. The method as recited in claim 1, wherein the step e) includes the steps of:
e1) extracting a virtual memory address of the executing file loaded on the virtual memory based on header information of the executing file; and
e2) modifying the private image stored on a virtual memory.

7. A method for treating a virus in real-time while executing a virus infected file, the method comprising the steps of:
a) obtaining a file object of the executing file to be modified;
b) modifying an original image stored on an address of a physical memory indicated by an image section of the executing file;
c) modifying a data image stored on an address of a physical memory indicated by a data section of the executing file;
d) obtaining a virtual memory address on which the executing file is loaded; and
e) modifying a private image on the virtual memory address.

8. The method as recited in claim 7, wherein the step b) includes the steps of:
b1) extracting an image section;
b2) extracting an address of a physical memory to which the image section is mapped; and
b3) modifying the original image mapped to the address of the physical memory.

9. The method as recited in claim 8, wherein the step b1) includes the steps of:
b1-1) detecting a section object pointers included in the file object;
b1-2) obtaining an image section pointers based on the section object pointers; and
b1-3) extracting the image section based on the image section pointers.

10. The method as recited in claim 7, wherein the step c) includes the steps of:
c1) extracting a data section of the executing file;
c2) extracting an address of a physical memory to which the data section is mapped; and
c3) modifying the data image loaded on the physical memory address; and
C4) at a page writer, writing the data image of the physical memory to a disk.

11. The method as recited in claim 10, wherein the step c1) includes the steps of:
c1-1) detecting a section object pointers included in the file object;
c1-2) obtaining a data section pointers based on the section object pointers; and
c1-3) extracting the data section based on the data section pointers.

12. The method as recited in claim 7, wherein the step e) includes the steps of:
e1) extracting a virtual memory address of the executing file loaded on the virtual memory based on header information of the executing file; and
e2) modifying the private image stored on a virtual memory.

13. A computer readable medium storing instructions for executing a method for treating a virus on real time while executing a virus infected file, the method comprising the steps of:
a) obtaining a file object of the executing file to be modified;
b) modifying an original image stored on an address of a physical memory indicated by an image section of the executing file;
c) modifying a data image stored on an address of a physical memory indicated by a data section of the executing file;
d) obtaining a virtual memory address on which the executing file is loaded; and
e) modifying a private image on the virtual memory address.
